(19) United States
(12) Patent Application Publication
(10) Pub. No.: US 2015/0086958 A1
(43) Pub. Date: Mar. 26, 2015

(54) MEDICAL TREATMENT SIMULATION DEVICES

(71) Applicant: Penny Lewis, Newark, DE (US)

(72) Inventor: Penny Lewis, Newark, DE (US)

(73) Assignee: University of Delaware, Newark, DE (US)

(21) Appl. No.: 14/496,396

(22) Filed: Sep. 25, 2014

Related U.S. Application Data
(60) Provisional application No. 61/882,107, filed on Sep. 25, 2013.

(51) Int. Cl. G09B 23/28; G09B 23/30; G06F 19/00

(52) U.S. Cl. CPC G09B 23/288; G06F 19/3437; G09B 23/30
USPC 434/267

(57) ABSTRACT

Medical treatment simulation devices are disclosed. One medical treatment simulation device is configured to be secured to a subject and to cover at least a portion of a torso of the subject. The medical treatment simulation device includes a base member, a movable member, and at least one sensor. The movable member is movably coupled to the base member. The movable member is biased to be in a predetermined position relative to the base member. The sensor is configured to detect a movement of the movable member relative to the base member.

### CROSS REFERENCE TO RELATED APPLICATIONS

This application claims priority to U.S. Patent Application No. 61/882,107, the contents of which are incorporated herein by reference in their entirety.

### FIELD OF THE INVENTION

The present invention relates generally to medical simulations, and more particularly, to simulation devices for training care providers to provide medical treatment.

### BACKGROUND OF THE INVENTION

Training care providers to administer cardiopulmonary resuscitation (CPR) treatment can be complicated due to the difficulty in simulating the actual conditions in which treatment is required. In particular, encountering a patient who is suffering from serious distress (e.g., panting, sweating, panicking, etc.) may invoke an emotional response in a care provider that can interfere with or overcome the provider's CPR training.

One possibility for overcoming this emotional response is providing training to CPR providers in which a real-life CPR scenario can be simulated. Such training may not be capable of simulation through the use of a conventional training mannequin. Conversely, conventional training programs do not allow for the provision of realistic CPR treatment to a patient actor, as such treatment may cause actual harm to the actor. Accordingly, improved systems and devices are desired for training CPR care providers to provide treatment.

### SUMMARY OF THE INVENTION

Aspects of the present invention are medical treatment simulation devices. In accordance with an aspect of the present invention, a medical treatment simulation device is configured to be secured to a subject and to cover at least a portion of a torso of the subject. The medical treatment simulation device includes a base member, a movable member, and at least one sensor. The movable member is movably coupled to the base member. The movable member is biased to be in a predetermined position relative to the base member. The sensor is configured to detect a movement of the movable member relative to the base member.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 is an image illustrating an exemplary medical treatment simulation device in accordance with aspects of the present invention;

FIG. 2 is a diagram illustrating an exemplary cross-section of the medical treatment simulation device of FIG. 1;

FIGS. 3A and 3B are diagrams illustrating exemplary layouts of the medical treatment simulation device of FIG. 1 relative to a human subject;

FIG. 4 is a diagram illustrating an exemplary base member of the medical treatment simulation device of FIG. 1;

FIG. 5 is a diagram illustrating an exemplary movable member of the medical treatment simulation device of FIG. 1; and

FIGS. 6A and 6B are diagrams illustrating exemplary sensor layouts of the medical treatment simulation device of FIG. 1.

### DETAILED DESCRIPTION OF THE INVENTION

Aspects of the invention are described herein with reference to simulating the treatment of patients requiring cardiopulmonary resuscitation (CPR). However, it will be understood by one of ordinary skill in the art that the exemplary devices described herein may be used to simulate treatment of a variety of medical conditions, and is not limited to CPR treatment. Other medical treatments suitable for simulation with the disclosed devices will be known to one of ordinary skill in the art from the description herein.

The exemplary devices disclosed herein may be particularly suitable for providing an enhanced level of feedback to the medical care provider relative to conventional training devices. Visual and/or haptic feedback may be provided to the care provider during treatment in order to reinforce proper techniques. Likewise, this feedback may be provided to correct treatment errors that the care provider may otherwise struggled to detect during the simulated treatment. The provision of feedback using the exemplary devices of the present invention may desirably improve the ability of medical care providers to comfortably and effectively treat patients.

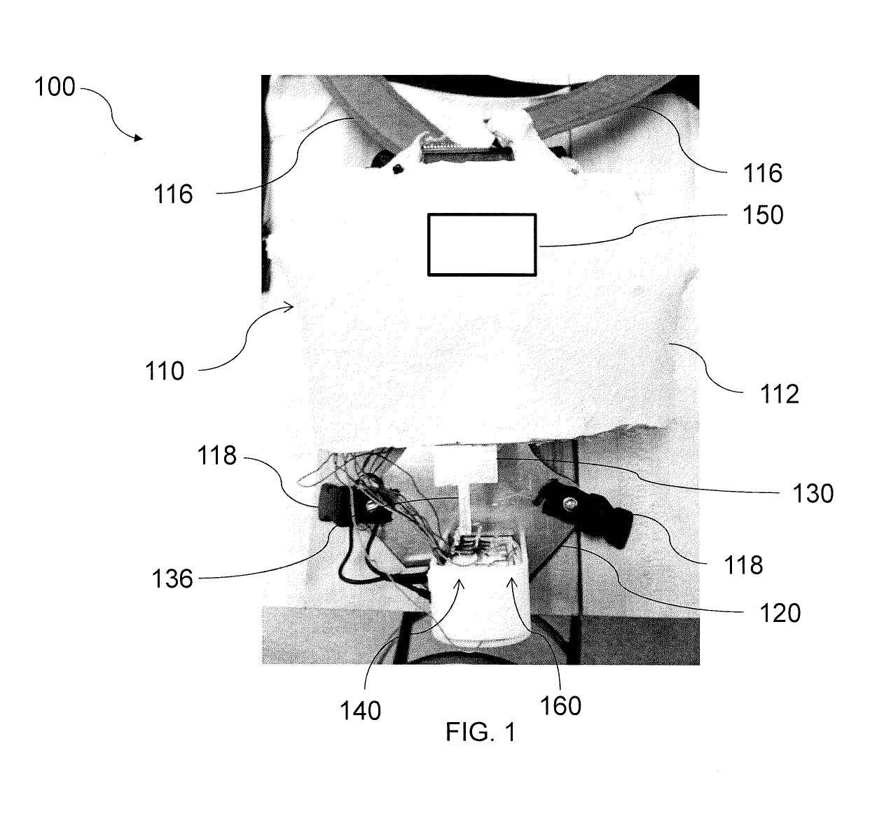

With reference to the drawings, FIG. 1 illustrates an exemplary medical treatment simulation device 100 in accordance with aspects of the present invention. Device 100 is usable to train medical care providers to provide CPR treatment to patients. In general, device 100 includes an overlay 110, a base member 120, a movable member 130, and at least one sensor 140. Additional details of device 100 are described below.

Overlay 110 is configured to be positioned overtop of a subject who is playing the role of the patient. When positioned overtop the subject, overlay 110 is configured to cover the subject's upper torso. In an exemplary embodiment, overlay 110 is shaped like a patient's upper torso, as shown in FIG. 1. Shaping overlay 110 as described above desirably limits the size of overlay 110, and allows the profile of overlay 110 to closely conform to the body of the subject, thereby allowing the subject to portray a CPR patient.

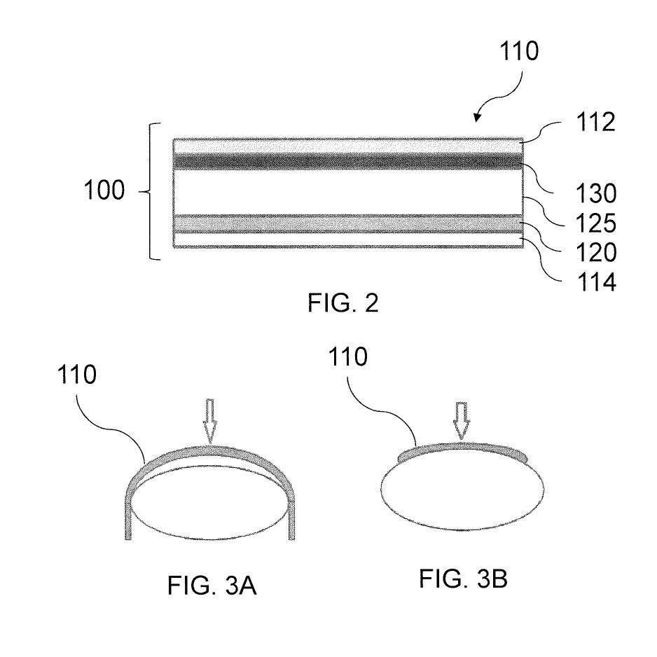

Overlay 110 may be formed from multiple pieces that connect to define an enclosure for the components of device 100. In an exemplary embodiment, overlay 110 is a housing including a front surface 112 and a rear surface 114, as shown in FIG. 2. FIG. 2 shows a cross-section illustrating the internal layout of device 100. Front surface 112 is configured to be removably connected to rear surface 114, for example, by straps, buttons, snaps, or any other structures known in the art. Inside the surfaces 112 and 114, base member 120 and movable member 130 are spaced from one another to form a cavity 125, as described in more detail below.

In an exemplary embodiment, front surface 112 of overlay 110 may be formed from a soft and pliable material intended to simulate the patient's skin (“artificial skin”), which may further include anatomically accurately positioned simulated nipples to facilitate proper hand placement for performing CPR. Likewise, rear surface 114 of overlay 110 may be formed from a soft foam material for providing comfort to the subject wearing device 100. These surface materials may be coupled to rigid shells designed to house the operational components of device 100 (e.g. sensors and feedback devices), thereby providing protection for these components and conceal wiring and other items.

In an exemplary embodiment, the artificial skin of front surface 112 of overlay 110 may include sound dampening material in order to dampen sounds generated within device 100. The artificial skin may further include memory foam, PVC, and/or elastomeric layers for simulating the patient's skin.

In one embodiment, the artificial skin may comprise a sheet of thermoplastic, such as a 3 mm thick sheet of low temperature thermoplastic manufactured by Allard USA, embedded in a silicone rubber gel, such as made by Smooth-On, Inc. Such a configuration may have a stiffness of several pounds per inch. One method of fabricating a suitable skin overlay comprises molding the thermoset plastic around a human individual's chest and then allowing it to cool. Another mold may then be created using a lifecasting technique utilizing plaster of Paris. The silicone rubber gel may then be painted onto the plaster of Paris mold in several layers, allowing sufficient curing time (roughly 10 minutes) between coats to ensure thickening of the silicone to avoid unwanted pooling. In one suitable embodiment, after applying three layers of the silicone rubber gel over the mold, the thermoplastic layer was then set in the mold and two additional layers of silicone were applied.

It will be understood that the selection, order, and thickness of layers of artificial skin are not limited. Other suitable materials for use in simulating a patient's skin will be generally known to one of ordinary skill in the art from the description herein.

Device 100 may further include a plurality of straps for securing overlay 110 to a subject. In an exemplary embodiment, the rear of device 100 includes a pair of straps 116 configured to encircle the subject's shoulders. Straps 116 are usable to secure device 100 to the subject during the simulated treatment. Device 100 may further include additional buckles 118 coupled to base member 120 for receiving straps. Buckles 118 can receive straps around the torso of the subject for securing device 100 during simulated treatment.

In a preferred embodiment, straps may extend between the upper and lower connections on overlay 110 in a cross-strap pattern. In other words, a strap may be attached to overlay 110 at the upper left and the lower right points, allowing a pair of straps to cross on the back of the subject. This may increase the stability and comfort of device 100 to the subject.

Device 100 is preferably designed to assist in distributing the force from chest compressions across device 100, to minimize force transfer to the subject wearing device 100. In one exemplary embodiment, overlay 110 extends over the top of the subject's torso and down the sides of the subject's torso, as shown in FIG. 3A. In this embodiment, overlay 110 or base member 120 contacts the floor or other surface on which the subject is lying. This may desirably assist in distributing the force of chest compressions into the floor or underlying structure, and away from the subject. In another exemplary embodiment, overlay 110 extends over substantially all of the subject's upper torso, as shown in FIG. 3B. In this embodiment, device 100 is formed with a relatively large surface area, which allows the force from chest compressions to spread out over the subject's entire upper torso. The embodiment shown in FIG. 3B may be preferable to assist in wearability of overlay 110, and realism of the simulated CPR treatment.

In an exemplary embodiment, base member 120 is formed from a rigid material such as metal (e.g. aluminum), plastic (such as polypropylene), or rigid fabric (such as KEVLAR). A layer of cushioning material, such as but not limited to memory foam, may be provided on a rear surface of base member 120 to form rear surface 114 of overlay 110. Base member and underlying rear surface 114 of device 100 are designed to be positioned against the chest of the subject when device 100 is secured to the subject. One or more coupling devices (such as straps) may be attached to base member 120 to couple device 100 to the subject.

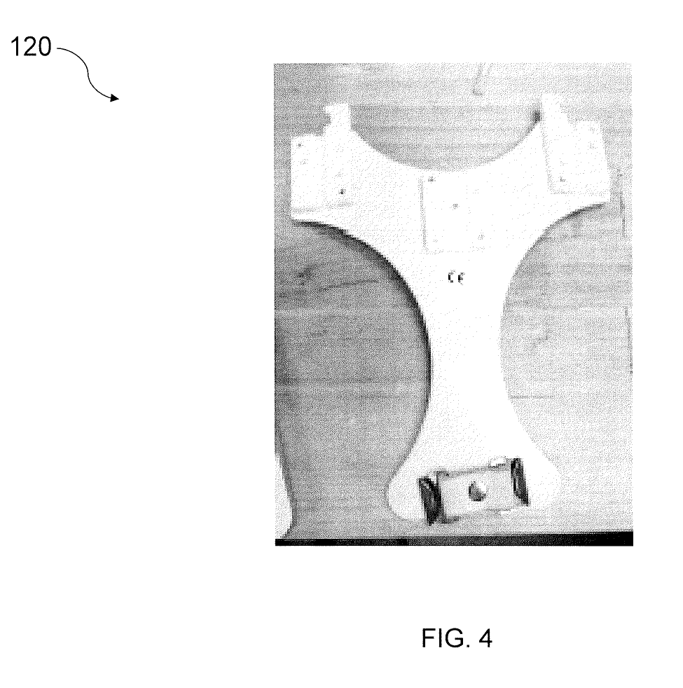

A suitable base member 120 for use with one embodiment of the present invention is depicted in FIG. 4. In the exemplary embodiment depicted in FIG. 4, base member 120 has a Y-shape, as shown in FIG. 4. The shape of base member 120 provides support for the additional components (e.g. movable member 130 and sensor 140) of device 100, as will be described below. Additionally, the Y-shape of base member 120 may be desirable for spreading out the applied force to peripheral areas of the subject's torso, thereby minimizing the force transferred to the subject. To this end, base member 120 has a profile corresponding to the profile of the human thoracic cavity, in order to further provide comfort and force distribution to the subject. Other possible shapes for use with base member 120 include, for example, circular or rectangular shapes.

Movable member 130 is movably coupled to base member 120. Movable member 130 is biased to be in a predetermined position relative to base member 120. Suitable for biasing movable member 130 will be described in greater detail below. Movable member 130 may be positioned directly against front surface 112 of overlay 110, such that front surface 112 of overlay 110 is secured to movable member 130.

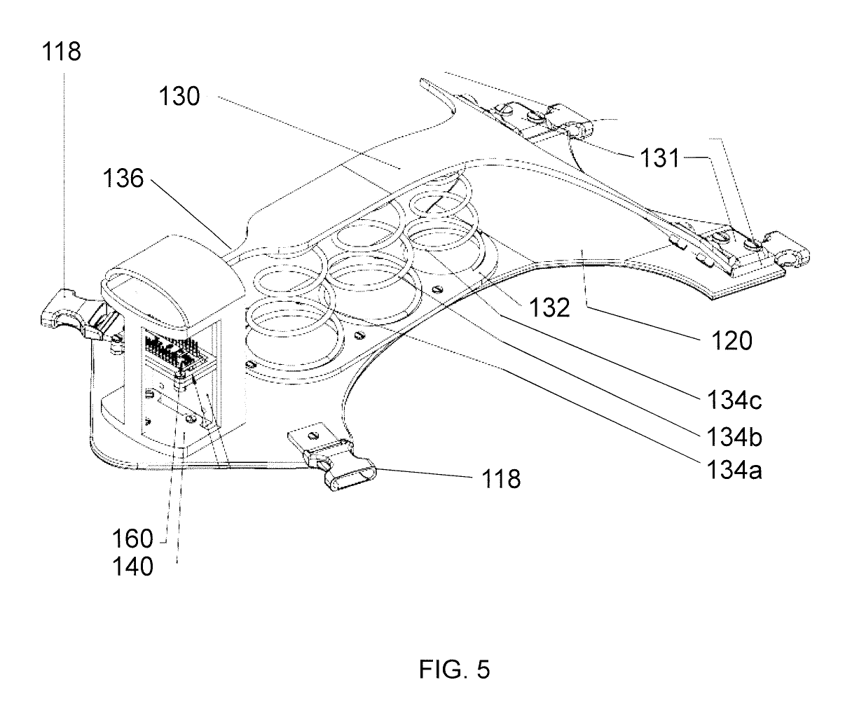

A suitable movable member 130 for use with the present invention is provided in FIG. 5 for the purpose of illustration. In an exemplary embodiment, a lower portion of the movable member 130 is shaped like a CPR patient's sternum. In this embodiment, the shape of movable member 130 may be useful for providing a more realistic feeling or feedback to the care provider using device 100. During the simulated CPR treatment, the care provider may be then position their hands relative to movable member 130 in a manner corresponding to the appropriate positioning of a care provider's hands when providing actual CPR treatment to a patient.

As shown in FIG. 5, movable member 130 has a Y-shape similar to the shape of base member 120. At the branched upper end, movable member 130 includes a pair of hinges 131 for allowing controlled relative movement between movable member 130 and base member 120. The control provided by hinges 131 causes the lower end of movable member 130 to move substantially in a single plane toward and away from base member 120.

Movable member 130 comprises a biasing element 132 for biasing movable member to be in the predetermined position. Biasing element 132 biases movable member 130 away from base member 120. In an exemplary embodiment, biasing element 132 comprises one or more springs coupled between base member 120 and movable member 130. The one or more springs have a length selected to place movable member 130 in the predetermined position when the springs reach their respective equilibrium lengths. Springs 134a-134c in part create the spacing between members 120 and 130 that defines cavity 125 within device 100 that acts as the simulated thoracic cavity for the simulated chest compressions.

As shown in FIG. 5, in an exemplary embodiment, biasing element 132 includes three springs 134a-134c. The springs are positioned approximately in a line between base member 120 and movable member 130. In this embodiment, one of the springs 134a may have a different spring constant from at least another one of the springs 134c. The use of different spring constants among the springs 134a-134c of biasing element 132 may be desirable in order to accurately simulate the resistive force provided by the overlay against the chest compressions performed by the care provider during simulated CPR treatment. Additional details regarding suitable force profiles for biasing element 132 are provided in greater detail below.

In an exemplary embodiment, springs 134a and 134b have an equilibrium height of between approximately 2.5-3.5 inches and a base diameter of approximately 2-2.5 inches. Spring 134c has an equilibrium height of between approximately 2-3 inches, and a base diameter of approximately 1.75-2 inches. In this embodiment, springs 134a and 134b have a spring constant between approximately 13-15 lbs./in, while spring 134c has a spring constant between approximately 11.5-13.5 lbs./in. Between springs 134a-134c and the natural stiffness from the remaining components (including overlay 110) which amount to between 3-6 lbs./in, device 100 incorporating biasing member 132 provides a realistic force curve simulating the force a care provider would experience when providing CPR treatment to an actual patient.

While springs 134a-134c in FIG. 5 are illustrated as coil springs, it will be understood that the invention is not so limited. Other suitable springs for use as biasing element 132 include, for example, torsional springs, volute springs, or leaf springs.

Sensor 140 is coupled to base member 120 and/or movable member 130. Sensor 140 is configured to detect certain movements of movable member 130 relative to base member 120. Exemplary embodiments of sensor 140 are set forth below.

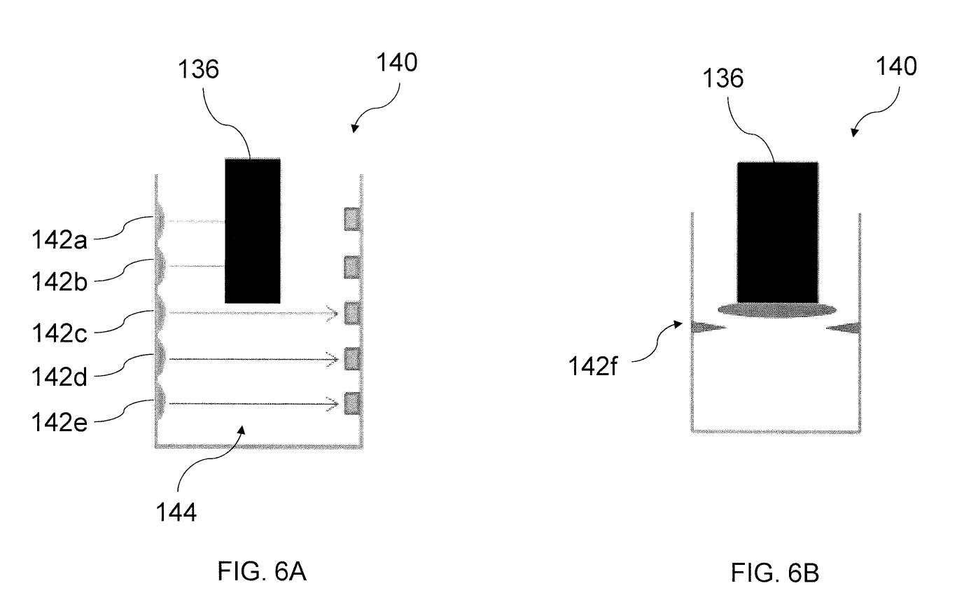

In one exemplary embodiment, sensor 140 comprises a plurality of optical sensors 142a, 142b, 142c, 142d, 142e, as shown in FIG. 6A. Optical sensors 142a-142e are configured to detect the total displacement of movable member 130 from the predetermined position. As shown in FIG. 6A, optical sensors 142-142e are arranged approximately in a line, and are positioned to detect movement within a slot or cavity 144 defined by sensor 140. The slot 144 extends between the movable member 130 and the base member 120. Optical sensors 142a-142e may be, for example, a series of infrared LED emitter and detector pairs spanning across slot 144, as shown in FIG. 6A. Each of the sensors 142a-142e may be spaced apart by an equal distance, e.g., between approximately one quarter and one half inch.

In this embodiment, movable member 130 comprises a projection 136 on an end thereof. The projection 136 is positioned within the slot 144 defined by sensor 140. As movable member 130 is moved during compressions by the care provider, projection 136 moves downward within slot 144, and interrupts the optical beams projected by optical sensors 142a-142e. The number of optical sensors 142a-142e triggered by projection 136 can be used to determine the total displacement of movable member 130. It will be understood that the number of optical sensors 142a-142e shown in FIG. 6A is provided for the purposes of illustration, and is not intended to be limiting.

In another exemplary embodiment, sensor 140 comprises a reed switch, as shown in FIG. 6B, configured to signal when movable member 130 has moved a predetermined amount from the predetermined rest position. As shown in FIG. 6B, reed switch sensor 140 comprises a magnet 142f coupled to base 120 and a reed switch element coupled to projection 136 of movable member 130. As is known in the art, a reed switch typically comprises a pair (or more) of magnetizable, flexible, metal reeds having end portions separated by a small gap when the switch is open, all hermetically sealed in opposite ends of a tubular glass envelope. The reed switch comprises a circuit that is adapted to change state (i.e. to close if normally open, or to open if normally closed) when the reed switch is in sufficient proximity to a magnetic field. Other technologies for causing an open or closed signal may also be provided in place of the reed switch, with similar functionality. Projection 136 may be a telescoping rod that permits selection of a desired compression depth for the simulated CPR treatment. In an exemplary embodiment, the predetermined amount is between approximately 3-6 cm.

In the reed switch embodiment, as movable member 130 is moved during compressions by the care provider, projection 136 moves downward, and the reed switch element mounted thereon passes through or sufficiently close to the magnetic field created by magnet 142f, thereby causing electrical contacts in the reed switch to change position, thereby creating a sensible change in an electrical signal. Thus, when triggered, the sensor 140 provides a signal that movable member 130 has moved the predetermined amount. This signal may be used to provide feedback to the care provider, as will be described in greater detail below. It will be understood that the predetermined amount of movement of movable member 130 may be adjusted by adjusting the length of the telescoping rod 136.

The above examples of types and layouts of sensors 140 are provided for the purposes of illustration, and are not intended to be limiting. It will be understood that a combination of the disclosed sensors may be used, and that additional types and layouts of sensors may be used, without departing from the scope of the invention.

For example, sensor 140 may comprise an accelerometer for sensing the movement of movable member 130. The sensed movement could be used to determine the displacement of movable member 130 and the force applied to movable member 130. Alternatively, sensor 140 may comprise a linear variable differential transformer (LVDT) configured to measure displacement of movable member 130 along a line extending between the predetermined position of movable member 130 and base member 120. The LVDT could be coupled to base member 120 so that it could be raised or lowered depending on a desired depth of compression/desired length of movement of movable member 130.

Other components usable to detect the movement and displacement of movable member 130 will be known to one of ordinary skill in the art from the description herein.

Device 100 is not limited to the above-described components, but can include alternate or additional components as would be understood to one of ordinary skill in the art in view of the examples below.

For example, device 100 may include a feedback device 150 to provide feedback to the user of device 100 (i.e. the care provider) based on the movement of movable member 130 detected by sensor 140. Feedback may be provided based on the movement of movable member 130 caused by the care provider during the compressions that are part of the simulated CPR treatment.

In an exemplary embodiment, feedback device 150 is a visual display. The display provides visual feedback to the user during the simulated treatment of the subject. The display may be mounted in the front surface 112 of overlay 110, in an area not likely to be contacted during simulated CPR treatment. Suitable displays for use as feedback device 150 include, for example, liquid crystal displays. Other display components for use as feedback device 150 will be known to those of ordinary skill in the art from the description herein.

In another exemplary embodiment, feedback device 150 is an audible alarm. The alarm generates a sound that can be heard by the user during the simulated treatment of the subject. Suitable loudspeakers for use as the audible alarm will be known to one of ordinary skill in the art from the description herein. Other feedback devices, or combinations thereof, will be known to one of ordinary skill in the art from the description herein.

For another example, device 100 may include a microcontroller 160. In an exemplary embodiment, microcontroller 160 is connected in communication with sensor 140 and feedback device 150. Microcontroller 160 processes the information detected by sensor 140, and operates feedback device 150 to provide the user with feedback based on the movement of movable member 130 detected by sensor 140. Examples of feedback provided by microcontroller 160 using feedback device 150 are set forth below.

In one exemplary embodiment, microcontroller 160 is programmed to operate feedback device 150 to display information to the user regarding the total displacement of movable member 130 relative to base member 120. In this embodiment, device 100 includes the sensor 140 illustrated in FIG. 6A, and a visual feedback device 150. Sensor 140 generates a signal representative of the total displacement of movable member 130 relative to base member 120. The signal is based on the number of optical sensors 142a-142e triggered by projection 136. This signal is communicated from sensor 140 to microcontroller 160. Microcontroller 160 then processes this information, and operates feedback device 150 to display to the user information regarding the displacement of movable member 130. This information may include, by way of example, the distance moved by movable member 130, i.e., the depth of the chest compression during the simulated treatment. For another example, the displayed information may include the force exerted on movable member 130 by the user, which microcontroller 160 may be configured to calculate from the distance moved by movable member 130. This calculation may be performed based on predetermined characteristics of movable member 130 and biasing member 132 (such as spring constants).

In another exemplary embodiment, microcontroller 160 is programmed to operate feedback device 150 to display information to the user regarding a frequency of movements of movable member 130 relative to base member 120. In this embodiment, device 100 may include the sensor 140 illustrated in FIG. 6B, and may include a visual and/or audio feedback device 150. Sensor 140 generates a signal representative of movement of movable member 130 a predetermined distance (e.g., an effective compression). This signal is communicated from sensor 140 to microcontroller 160. Microcontroller 160 then processes this information, and operates feedback device 150 to display to the user information regarding the compressions of movable member 130. This information may include, by way of example, the frequency of movements of movable member 130 (i.e., the frequency of chest compressions). This frequency may be displayed numerically, or may be broadcast audibly to the user (e.g., as a series of beeps corresponding to the compressions).

Additionally or alternatively, microcontroller 160 may operate an audio feedback device 150 to produce sounds corresponding to a desired frequency for the chest compressions (e.g., again, as a series of beeps with which the user should attempt to keep time). In an exemplary embodiment, feedback device 150 may a metronome tuned to emit sounds at the desired frequency, which can be switched on and off either manually (by the user or subject) or automatically (by microcontroller 160).

The above described medical treatment simulation device provides advantages not found in conventional devices as set forth below. In particular, the disclosed embodiments provide treatment devices that allow a care provider to simulate the provision of CPR treatment to a living patient, as opposed to a non-moving, non-responsive mannequin or dummy. Additionally, the expansive size contouring of the base member, along with the biased connection between the movable member and the base member, allows for the dissipation of force from chest compressions during the simulated treatment, thereby creating a safe environment for the subject. During proper simulated CPR treatment, the disclosed devices will result in a chest pressure well below the pain or danger threshold for the subject, e.g., a PSI of 1.55 or less.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A medical treatment simulation device configured to be secured to a subject and to cover at least a portion of a torso of the subject, the device comprising:
a base member;
a movable member movably coupled to the base member, the movable member biased to be in a predetermined position relative to the base member; and
at least one sensor configured to detect a movement of the movable member relative to the base member.

2. The device of claim 1, wherein the device comprises an overlay shaped like an upper torso of a patient.

3. The device of claim 2, wherein the overlay is formed from a soft, pliable material disposed over the movable member and configured to simulate human skin.

4. The device of claim 1, wherein the movable member is shaped like a sternum of a patient.

5. The device of claim 1, wherein the movable member is provided in direct contact with an upper surface of the device.

6. The device of claim 1, wherein the at least one sensor comprises a plurality of optical sensors configured to detect a total displacement of the movable member from the predetermined position.

7. The device of claim 6, wherein the plurality of optical sensors comprise a slot extending between the base member and the movable member, and the movable member comprises a projection positioned within the slot, the plurality of optical sensors detecting the total displacement of the movable member based on the movement of the projection within the slot.

8. The device of claim 1, further comprising one or more springs coupled between the base member and the movable member, the one or more springs configured to bias the movable member to be in the predetermined position.

9. The device of claim 8, wherein the one or more springs comprise a plurality of springs, and at least one of the plurality of springs has a different spring constant than at least another one of the plurality of springs.

10. The device of claim 1, further comprising at least one feedback device coupled to the overlay, the feedback device configured to provide feedback based on the movement of the movable member detected by the at least one sensor.

11. The device of claim 10, wherein the feedback device comprises a display for providing visual feedback to a user.

12. The device of claim 10, further comprising a microcontroller connected to the at least one sensor and the at least one feedback device, the microcontroller configured to process signals from the at least one sensor and send a signal to operate the at least one feedback device based on the signals from the at least one sensor.

13. The device of claim 12, wherein the microcontroller is programmed to operate the at least one feedback device to display information to the user regarding a total displacement of the movable member relative to the base member.

14. The device of claim 12, wherein the microcontroller is programmed to operate the at least one feedback device to display information to the user regarding a frequency of movements of the movable member relative to the base member.

15. The device of claim 12, wherein the microcontroller is programmed to operate the at least one feedback device to generate sounds corresponding to a desired frequency of movements of the movable member relative to the base member.

16. The device of claim 3, further comprising a cushion layer disposed underneath the base member.

17. The device of claim 16, wherein the cushion layer comprises memory foam.

18. The device of claim 3, wherein the soft, pliable material comprises a composite including a combination of thermoplastic and silicone gel.

19. The device of claim 3, wherein top overlay further comprises anatomically accurately positioned simulated nipples.
